(19) United States
(12) Patent Application Publication
(10) Pub. No.: US 2014/0078264 A1
(43) Pub. Date: Mar. 20, 2014

(54) ABSOLUTE THREE-DIMENSIONAL SHAPE MEASUREMENT USING CODED FRINGE PATTERNS WITHOUT PHASE UNWRAPPING OR PROJECTOR CALIBRATION

(71) Applicant: Iowa State University Research Foundation, Inc., Ames, IA (US)

(72) Inventor: Song Zhang, Ames, IA (US)

(73) Assignee: Iowa State University Research Foundation, Inc., Ames, IA (US)

(21) Appl. No.: 14/098,718

(22) Filed: Dec. 6, 2013

(51) Int. Cl. G01B 11/25; H04N 9/31; H04N 13/02

(52) U.S. Cl. CPC G01B 11/2545; H04N 13/0239; H04N 9/31
USPC 348/47

(57) ABSTRACT

A stereo-phase-based absolute three-dimensional (3D) shape measurement method is provided that requires neither phase unwrapping nor projector calibration. This proposed method can be divided into two steps: (1) obtain a coarse disparity map from the quality map; and (2) refine the disparity map using local phase information. Experiments demonstrated that the proposed method could achieve high-quality 3D measurement even with extremely low-quality fringe patterns. The method is particular well-suited for a number of different applications including in mobile devices such as phones.

### FIELD OF THE INVENTION

The present relates to three-dimensional shape measurement.

### BACKGROUND OF THE INVENTION

Triangulation-based three-dimensional (3D) shape measurement can be classified into two categories: the passive method (e.g. stereo vision) and the active method (e.g., structured light). In a passive stereo system, two images captured from different perspectives are used to detect corresponding points in a scene to obtain 3D geometry [1, 2]. Detecting corresponding points between two stereo images is a well-studied problem in stereo vision. Since a corresponding point pair must lie on an epipolar line, the captured images are often rectified so that the epipolar lines run across the row [3]. This allows a method of finding corresponding points using a “sliding window” approach, which defines the similarity of a match using cost, correlation, or probability. The difference between the horizontal position of the point in the left image and that in the right image is called the disparity. This disparity can be directly converted into 3D geometry.

Standard cost-based matching approaches rely on the texture difference between a source point in one image with a target point in the other [4]. The cost represents the difference in intensity between the two windows on the epipolar line and is used to weigh various matches. In a winner-takes-all approach, the disparity will be determined from the point in the right image that has the least cost with that of the source point in the left.

In addition to local methods, a number of global and semi-global methods have been suggested [5, 6, 7, 8]. One method that worked especially well was the probabilistic model named Efficient Large-Scale Stereo (ELAS) [9]. In this method, a number of support points from both images are chosen based on their response to a 3×3 Sobel filter. Groups of points are compared between images, and a Bayesian model determines their likelihood of matching. Since the ELAS method is piecewise continuous, it works particularly well for objects with little texture variation.

Passive stereo methods, despite recent advances, still suffer from the fundamental limitation of the method: finding corresponding pairs between two natural images. This requirement hinders the ability of this method to accurately and densely reconstruct many real-world objects such as uniform white surfaces. An alternative to a dual-camera stereo method is to replace one camera with a projector and actively project desired texture on the object surface for stereo matching [10]. This method is typically referred to as structured light. The phase-shifting-based structured-light method (also called digital fringe projection or DFP method) is widely used due to its accuracy and speed. For a DFP system, instead of finding corresponding point on the projected texture, it uses phase as a constraint to solve for (x; y; z) coordinates pixel by pixel if the system is calibrated [11].

While the active DFP technique has numerous advantages over passive stereo methods, it also suffers from several problems. Firstly, the absolute phase must be obtained, usually requiring spatial or temporal phase unwrapping. The spatial phase unwrapping cannot be used for large step-height or isolated object measurement, and the temporal phase unwrapping requires more images to be captured, slowing down the measurement speed. Secondly, since this method recovers 3D geometry directly from the phase, the phase quality is essential to measurement accuracy: any noise or distortion on the phase will be reflected on the final 3D measurement. Lastly, the projector has to be accurately calibrated [12]. Even though numerous projector calibration methods have been developed, accurate projector calibration remains difficult because, unlike a camera, a projector cannot directly capture images.

To mitigate the problems associated with passive stereo or actively structured light methods, the natural approach is to combine these two methods together: using two cameras and one projector. Over the years, different methods have been developed. In general, they use either binary-coded patterns [13, 14, 15] or phase-shifted sinusoidal fringe patterns [16, 17, 18]. An overview can be found in [19, 20, 21]. Typically, the latter can achieve higher spatial resolution (camera pixel) than the former. More important, the phase-based method could also achieve higher speed since only three patterns are required for dense 3D shape measurement.

The phase-based method becomes more powerful if neither spatial nor temporal phase unwrapping is necessary. Taking advantage of the geometric constraints of the trio sensors (two cameras and one projector), References [22, 23, 24] presented 3D shape measurement techniques without phase unwrapping. However, similar to prior phase-based methods, these methods require projector calibration, which is usually not easy and even more difficult for nonlinear projection sources. Furthermore, the geometric constraint usually requires globally backward and forward checking for matching point location, limiting its speed and capability of measuring sharp changing surface geometries.

What is needed is an improved methodology for absolute three-dimensional shape measurement.

### SUMMARY OF THE INVENTION

Therefore, it is a primary object, feature, or advantage of the present invention to improve over the state of the art.

It is a further object, feature, or advantage of the present invention to provide a method for three-dimensional shape measurement that does not require any geometric constraint imposed by the projector.

It is a still further object, feature, or advantage of the present invention to provide a method for three-dimensional shape measurement that does not require projector calibration.

Another object, feature, or advantage of the present invention to provide a method for three-dimensional shape measurement without using a traditional spatial or temporal phase unwrapping algorithm.

Yet another object, feature, or advantage of the present invention is to provide a method for three-dimensional shape measurement without requiring a high-quality phase map.

A further object, feature, or advantage of the present invention provide a method for three-dimensional shape measurement which may be used with cell phones or other consumer devices.

One or more of these and/or other objects, features, or advantages of the present invention will become apparent from the specification and claims that follow. No single embodiment need exhibit each or every object, feature, or advantages as it is contemplated that different embodiments may have different objects, features, and advantages.

A novel method is presented for 3D absolute shape measurement without a traditional spatial or temporal phase unwrapping algorithm. The quality map of the phase-shifted fringe patterns may be encoded for rough disparity map determination by employing the ELAS algorithm, and the wrapped phase to refine the rough disparity map for high-quality 3D shape measurement. The method also does not require any projector calibration, or high-quality phase map, and thus could potentially simplify the 3D shape measurement system development including the ability to use cell phones or other consumer devices. Experimental results demonstrated the success of the proposed technique.

According to one aspect, a method for three-dimensional (3D) shape measurement is provided. The method includes providing a system comprising a first camera, a second camera, and a projector, combining phase-shifting fringe patterns with statistically random patterns to produce modified phase-shifting fringe patterns, projecting these phase-shifting patterns with the projector onto a surface, acquiring imagery of the surface using the first camera and the second camera, applying a stereo matching algorithm to the imagery to obtain a coarse disparity map (this can be used for low resolution 3D geometry reconstruction), and using local phase information (such as in the form of a wrapped or unwrapped phase map) to further refine the coarse disparity map to thereby provide the high-resolution 3D shape measurement. The patterns may be further binarized using a dithering technique or other technique; or the original sinusoidal patterns may be directly dithered where the statistical patterns are naturally imbedded with the dithered pattern.

According to another aspect of the present invention, an apparatus for 3-D shape measurement is provided. The apparatus includes a first camera, a second camera, a projector, and a computing device operatively connected to the first camera, the second camera, and the projector. The computing device is configured to perform the step of combining phase-shifting fringe patterns with statistically random patterns to produce modified phase-shifting fringe patterns, projecting the modified phase-shifting patterns with the projector onto a surface, acquiring imagery of the surface using the first camera and the second camera. The patterns can be dithered sinusoidal patterns or dithered modified patterns. The method further includes applying a stereo matching algorithm to the imagery to obtain a coarse disparity map, and using local phase information to further refine the coarse disparity map to thereby provide the 3D shape measurement.

### BRIEF DESCRIPTION OF THE DRAWINGS

FIGS. 1A-1B provide an example of 1/f noise used for encoded pattern. FIG. 1A illustrates encoded pattern, Iₚ (x, y); FIG. 1B illustrates a modified fringe pattern.

FIG. 2 is a photograph of a developed prototype hardware system.

FIGS. 3A-3F illustrate experimental results of a smooth sphere. FIG. 3A illustrates one of three fringe patterns from a left camera. FIG. 3B illustrates a wrapped phase map. FIG. 3C illustrates a quality map, g(x; y). FIGS. 3D-3F illustrate corresponding images for the right camera.

FIGS. 4A-4F illustrate experimental results of a smooth sphere. FIG. 4A is a photograph of a measured sphere. FIG. 4B illustrates a coarse disparity map using the ELAS algorithm. FIG. 4C illustrates a refined disparity map using wrapped phase. FIG. 4D illustrates a 3D result using the coarse disparity map of FIG. 4B. FIG. 4E illustrates 3D reconstruction using the refined disparity map of FIG. 4C. FIG. 4F illustrates an unwrapped phase after removing gross slope.

FIGS. 5A-5F illustrate surface measurement error for different methods. FIG. 5A illustrates a normalized cross-section of the 3D result shown in FIG. 4D. FIG. 5B illustrates a normalized cross-section of the 3D result shown in FIG. 4E. FIG. 5C illustrates a normalized cross-section of the 3D result shown in FIG. 4F. FIGS. 4D-4F show the difference between the 3D result with the fitted smooth surface.

FIGS. 6A-6F illustrate experimental results of more complex objects. FIG. 6A illustrates a photograph of measured statues; FIG. 6B illustrates a quality map showing an encoded pattern. FIG. 6C illustrates a coarse disparity map using the ELAS algorithm. FIG. 6D illustrates a refined disparity map using wrapped phase. FIG. 6E illustrates a close-up view of FIG. 6C. FIG. 6F illustrates a close-up view of FIG. 6D.

FIG. 7 is a block diagram of a mobile phone.

FIG. 8A is a pictorial representation of an example of a front of a mobile phone.

FIG. 8B is a pictorial representation of an example of a back of a mobile phone.

FIG. 9 is a pictorial representation of a monitor or display enabled with 3D shape measurement acquisition hardware.

FIG. 10 is a pictorial representation of a laptop computer enabled with 3D shape measurement acquisition hardware.

FIG. 11 is a diagram of one example of a slide projector configuration.

FIG. 12 is a diagram of another example of a slide projector configuration.

### DETAILED DESCRIPTION OF THE PREFERRED EMBODIMENTS

### 1. Introduction

Triangulation-based three-dimensional (3D) shape measurement can be classified into two categories: the passive method (e.g. stereo vision) and the active method (e.g., structured light). In a passive stereo system, two images captured from different perspectives are used to detect corresponding points in a scene to obtain 3D geometry [1, 2]. Detecting corresponding points between two stereo images is a well-studied problem in stereo vision. Since a corresponding point pair must lie on an epipolar line, the captured images are often rectified so that the epipolar lines run across the row [3]. This allows a method of finding corresponding points using a “sliding window” approach, which defines the similarity of a match using cost, correlation, or probability. The difference between the horizontal position of the point in the left image and that in the right image is called the disparity. This disparity can be directly converted into 3D geometry.

Standard cost-based matching approaches rely on the texture difference between a source point in one image with a target point in the other [4]. The cost represents the difference in intensity between the two windows on the epipolar line and is used to weigh various matches. In a winner-takes-all approach, the disparity will be determined from the point in the right image that has the least cost with that of the source point in the left.

In addition to local methods, a number of global and semi-global methods have been suggested [5, 6, 7, 8]. One method that worked especially well was the probabilistic model named Efficient Large-Scale Stereo (ELAS) [9]. In this method, a number of support points from both images are chosen based on their response to a 3×3 Sobel filter. Groups of points are compared between images, and a Bayesian model determines their likelihood of matching. Since the ELAS method is piecewise continuous, it works particularly well for objects with little texture variation.

Passive stereo methods, despite recent advances, still suffer from the fundamental limitation of the method: finding corresponding pairs between two natural images. This requirement hinders the ability of this method to accurately and densely reconstruct many real-world objects such as uniform white surfaces.

An alternative to a dual-camera stereo method is to replace one camera with a projector and actively project desired texture on the object surface for stereo matching [10]. This method is typically referred to as structured light. The phase-shifting-based structured-light method (also called digital fringe projection or DFP method) is widely used due to its accuracy and speed. For a DFP system, instead of finding corresponding point on the projected texture, it uses phase as a constraint to solve for (x; y; z) coordinates pixel by pixel if the system is calibrated [11].

While the active DFP technique has numerous advantages over passive stereo methods, it also suffers from several problems. Firstly, the absolute phase must be obtained, usually requiring spatial or temporal phase unwrapping. The spatial phase unwrapping cannot be used for large step-height or isolated object measurement, and the temporal phase unwrapping requires more images to be captured, slowing down the measurement speed. Secondly, since this method recovers 3D geometry directly from the phase, the phase quality is essential to measurement accuracy: any noise or distortion on the phase will be reflected on the final 3D measurement. Lastly, the projector has to be accurately calibrated [12]. Even though numerous projector calibration methods have been developed, accurate projector calibration remains difficult because, unlike a camera, a projector cannot directly capture images.

To mitigate the problems associated with passive stereo or actively structured light methods, the natural approach is to combine these two methods together: using two cameras and one projector. Over the years, different methods have been developed. In general, they use either binary-coded patterns [13, 14, 15] or phase-shifted sinusoidal fringe patterns [16, 17, 18]. An overview can be found in [19, 20, 21]. Typically, the latter can achieve higher spatial resolution (camera pixel) than the former. More important, the phase-based method could also achieve higher speed since only three patterns are required for dense 3D shape measurement.

The phase-based method becomes more powerful if neither spatial nor temporal phase unwrapping is necessary. Taking advantage of the geometric constraints of the trio sensors (two cameras and one projector), References [22, 23, 24] presented 3D shape measurement techniques without phase unwrapping. However, similar to prior phase-based methods, these methods require projector calibration, which is usually not easy and even more difficult for nonlinear projection sources. Furthermore, the geometric constraint usually requires globally backward and forward checking for matching point location, limiting its speed and capability of measuring sharp changing surface geometries.

The present invention provides a method to alleviate the problems associated with the aforementioned techniques. This method combines the advantages of the stereo approach and the phase-based approach: using a stereo matching algorithm to obtain the coarse disparity map to avoid the global searching problem associated with the method in Ref. [22]; and using the local wrapped phase information to further refine the coarse disparity for higher measurement accuracy. Furthermore, the proposed method does not require any geometric constraint imposed by the projector, and thus no projector calibration is required, further simplifying the system development.

Section 2 explains the principle of the proposed method. Section 3 shows the experimental results. Section 4 discusses the advantages and shortcomings of the proposed method, and Section 5 summarizes the methodology, and Section 6 describes various examples of applications for the method.

### 2. Principle

### 2.1. Three-Step Phase-Shifting Algorithm

For high-speed applications, a three phase-shifting algorithm is desirable. For a three-step phase-shifting algorithm with equal phase shifts, three fringe patterns can be described as

I₁(x,y)=I¹+I¹¹ cos (φ−2π/3), (1)

I₂(x,y)=I¹+I¹¹ cos (φ). (2)

I₃(x,y)=I¹+I¹¹ cos (φ+2π/3), (3)

where I¹(x, y) represents the average intensity, I¹¹(x, y) the intensity modulation, and φ (x, y) the phase to be solved for. Solving these three equations leads to

$$\begin{matrix}φ ( x , y ) = {tan}^{- 1} [ \frac{\sqrt{3} ( {I}_{1} - {I}_{3} )}{2 {I}_{2} - {I}_{1} - {I}_{3}} ] , & ( 4 ) \\ γ ( x , y ) = \frac{{I}^{″}}{{I}^{′}} = \frac{\sqrt{3 {( {I}_{1} - {I}_{3} )}^{2} + {( 2 {I}_{2} - {I}_{1} - {I}_{3} )}^{2}}}{{I}_{1} + {I}_{2} + {I}_{3}} . & ( 5 )\end{matrix}$$

Here γ(x, y) is the data modulation that represents the quality of each data point with 1 being the best, and its map is referred to as the quality map.

### 2.2. Combination of Statistical Random Pattern With Phase-Shifting Fringe Pattern

The key to the success of the proposed method is using the stereo algorithm to provide a coarse disparity map. However, none of these parameters, I¹; I¹¹; or φ will provide information about match correspondence for a case like a uniform flat board. To solve this problem without increasing the number of fringe patterns used, we could encode one or more of these variables to make them locally unique. Since the phase φ is most closely related to the 3D measurement quality and we often want to capture an unmodified texture, we propose to change I¹¹.

The encoded pattern was generated using band limited 1/f noise where

$$\frac{1}{20 pixels} < f < \frac{1}{5 pixels}$$

and with intensity Iₚ (x, y) such that 0:5<Iₚ (x, y)<1. In Eqs. (1)-(3), I¹¹ (x, y) was changed to Iₚ (x, y)I¹¹ (x, y). The modified fringe images are described as

I₁(x, y)=I¹+Iₚ(x, y)I¹¹ cos(φ−2π/3). (6)

I₂(x, y)=I¹+Iₚ(x, y)I¹¹ cos(φ), (7)

I₃(x, y)=I¹+Iₚ(x, y)I¹¹ cos(φ+2π/3). (8)

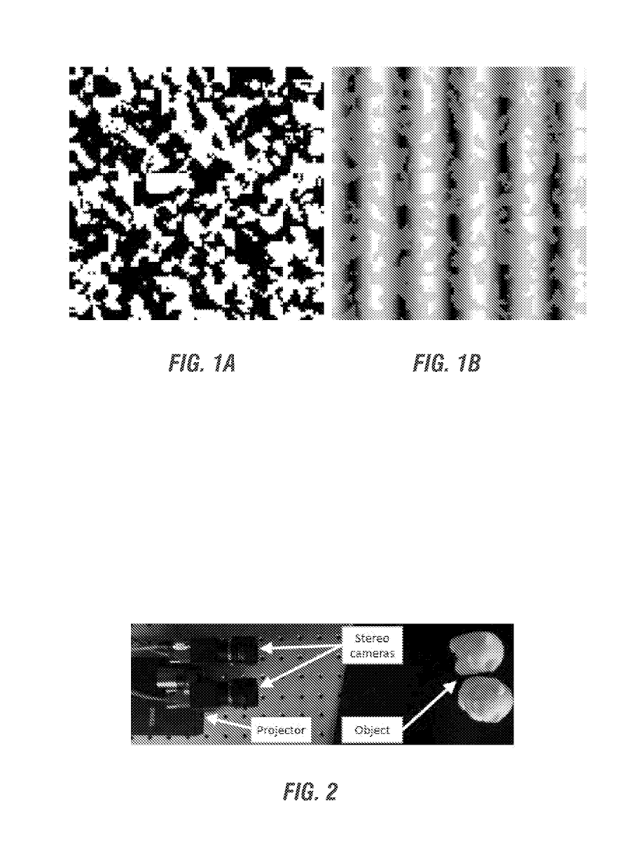

FIG. 1 illustrates the encoded pattern Ip(x; y) and one of the modified fringe patterns. Since the encoded pattern is still centered around the same average intensity value, the captured texture image or phase should not be affected in theory, albeit the phase signal to noise ratio may be lower, and the nonlinearity of the projection system may affect texture image quality. Furthermore, any naturally occurring quality map changes caused by object texture or proximity to the projector will be visible from both of the cameras, canceling the effect. The 2D varying pattern can improve the cost distinction between a correct match and the other possible disparities. While random pattern stereo matching algorithms have been proposed [25, 26], they have been used for the final disparity calculation rather than as an intermediary to matching phase. Here, the random pattern is used to match corresponding phase points between two images, without the need for global phase unwrapping. Once the corresponding points have been determined, refinement of the disparity map can proceed using only the wrapped phase locally.

### 2.3. Disparity Map Determination

ELAS [9] is used to obtain an initial coarse disparity map. Since the pattern encoded in g(x, y) provides great distinctness for many of the pixels, it produces a much more accurate map than just the texture I¹ (x, y). The encoded random pattern can be converted to an 8-bit grayscale image by scaling the intensity values for quality between 0 and 1 for input into ELAS.

The coarse disparity map provides a rough correspondence between images. However, it must still be refined to obtain a sub-pixel disparity. While the refinement could be performed on the random pattern itself, refinement using phase has several advantages: the phase is less sensitive to noise and monotonically increases across the image even in the presence of some level of higher-order harmonics.

Unlike the spatial or temporal unwrapping methods that require absolute phase, the proposed method only requires a local unwrapping window along a 3- to 5-pixel line. In a correct match, both the source and the target will lie within π radians, and this constraint can be used to properly align the phases.

The refinement step is defined as finding the sub-pixel shift t such that the center of the target phase matches the center of the source phase:

x_{target}(φ)+τ=x_{source}(φ) (9)

The relationship between the x-coordinate and the phase should locally have the same underlying curve for both the target and the source except for the displacement τ, so x(φ) can be fitted using a polynomial aₙφⁿ, where both the target and the source share the same parameters aₙ for n>0.

x_{target}(φ)=a₀^{t}+a₁φ+a₂φ²+a₃φ³ (10)

x_{target}(φ)=a₀^{s}+a₁φ+a₂φ²+a₃φ³ (11)

We found that the third-order polynomial fittings were sufficient to refine the disparity. The subpixel shift will be the displacement when φ source=0, yielding τ=a^{t}₀−a^{s}₀ and a final disparity of d=d_{coarse}−τ, where d_{coarse} is the coarse disparity for that pixel.

### 3. Experiments

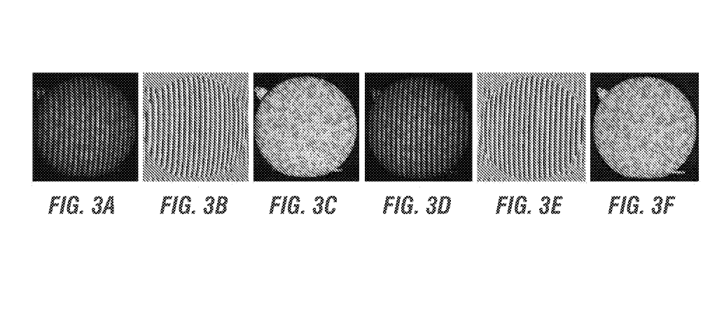

We developed a hardware system to verify the proposed technique, as shown in FIG. 3. This system includes an LED digital-light-processing (DLP) projector (model: Dell M109S) and two CMOS cameras (model: Point Grey Research Flea3 FL3-U3-13Y3M-C) with 12 mm lenses (model: Computar 08K). The projector resolution is 800×600. The cameras use USB 3.0 connection and are set as capturing images with a resolution of 800×600. The two cameras were calibrated using the asymmetric circle grid and the open-source software package OpenCV. Throughout the whole experiments, the projector remained uncalibrated (neither nonlinear gamma nor optical system parameters).

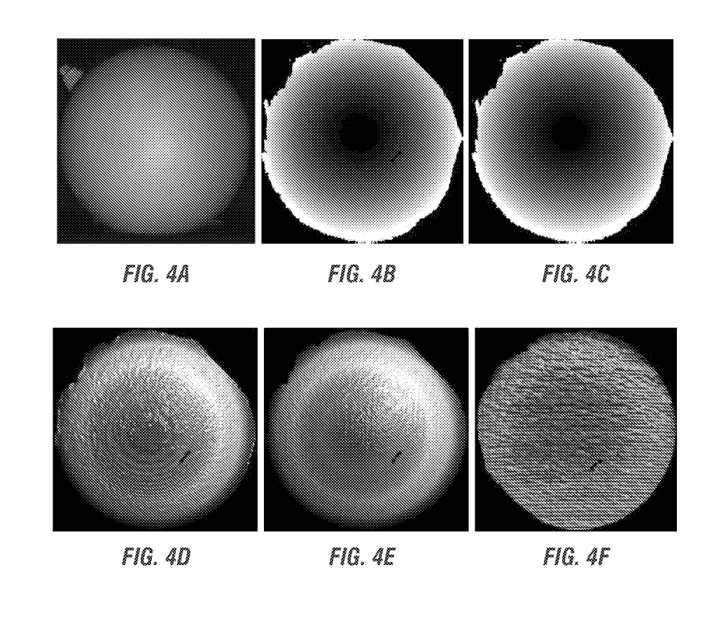

FIGS. 3A-3F and 4A-4F show the experimental results of measuring a smooth spherical surface shown in FIG. 4A, that usually fails the traditional stereo system since there is no substantial texture variation from one point to the other. FIG. 3A shows one of the three phase-shifted fringe patterns captured from the left camera. From three fringe patterns, the wrapped phase map, shown in FIG. 3B, and the quality map, shown in FIG. 3C, can be obtained. Similar images were also obtained for the right camera shown in FIGS. 3D-3F. From the quality maps, one may notice that, besides the encoded random information, there are some vertical structured patterns which are usually not present in a normal DFP system. This is caused by the projector's nonlinear effect as the projector is not calibrated.

FIG. 4B shows the coarse disparity map that was obtained from two camera's quality maps employing the ELAS algorithm; and FIG. 4C shows the refined disparity map using the wrapped phase. From the disparity maps, 3D shapes were reconstructed using the calibrated stereo camera system. FIG. 4D and FIG. 4E, respectively shows the result from the coarse disparity map, and the refined disparity map. These results demonstrate that the 3D reconstruction from coarse disparity map is very rough (i.e., not detailed) even with the encoded quality map. The 3D refined results using wrapped phase gives more detailed and accurate measurement. It should be noted that since the fringe patterns are encoded and the projector is not calibrated, the phase quality is very poor. FIG. 4F shows the unwrapped phase map after removing its gross slope, and the phase was unwrapped by using a multiple-frequency temporal phase unwrapping algorithm [27].

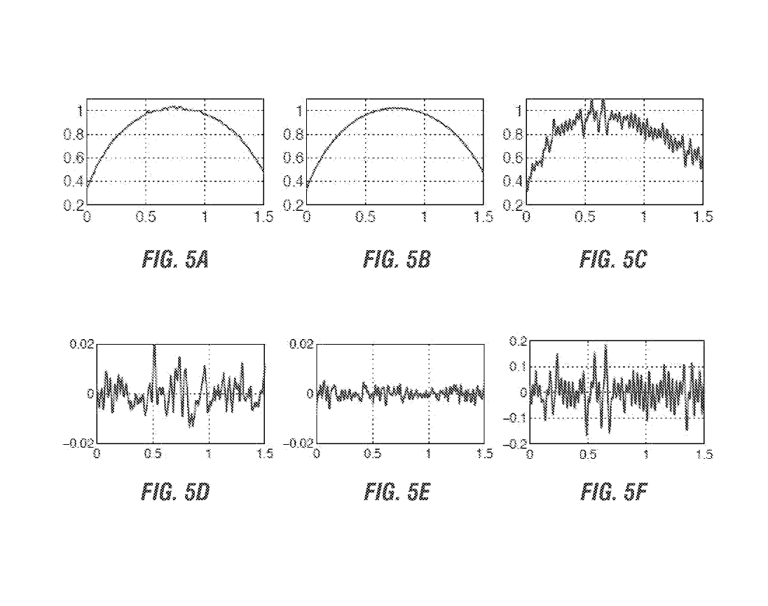

To further demonstrate the differences among these different approaches for smooth spherical surface measurement, we performed further analysis. Since the projector was not calibrated throughout the whole experiments, the 3D result from the conventional reference-plane based method cannot achieve the same measurement accuracy as the stereo-based method. To provide a fair comparison, the sphere was normalized to reflect the relative error rather than absolute error for all these results, as illustrated in FIG. 5A-5E. FIG. 5A shows the normalized cross-section of the 3D result shown in FIG. 4D; FIG. 5B shows the same normalized cross-section of the 3D result shown in FIG. 4E; and FIG. 5C shows the normalized cross-section of the 3D result shown in FIG. 4F.

Since the spherical surface we measured is smooth, we then fit these curves with smooth curve to find out the difference error between the normalized 3D results and the smoothed ones. FIGS. 5D-5E show the results. It should be noted the scale on FIG. 5F is 10 times that of FIG. 5D and FIG. 5E. This data clearly demonstrates that even from the poor quality of the phase, the high-quality 3D shape can still be properly reconstructed with the proposed method. This is the because, unlike a single camera DFP system where 3D information is directly extracted from phase, the proposed stereo system only uses the phase as a reference constraint to establish correspondence.

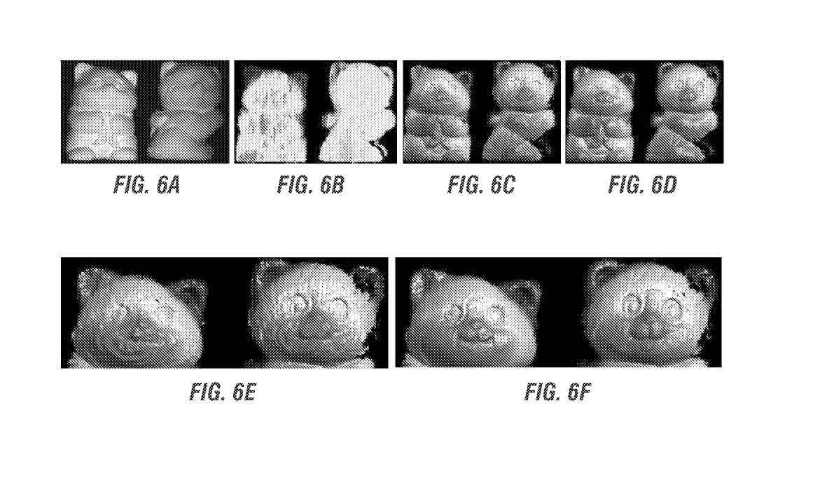

To verify that the proposed method can measure more complex and absolute shape of the object, FIGS. 6A-6F shows the results of simultaneously measuring two separate statues of size 62mm×42 mm×40 mm. Again, the phase quality is of very poor quality as shown in FIG. 6B, but high-quality 3D shape can be obtained using the proposed method shown in FIGS. 6D and 6F, which is substantially better than the result (FIG. 6C and FIG. 6E) obtained from the ELAS stereo matching algorithm. These experimental results further confirmed that the proposed method could be applied to arbitrary 3D shape measurement, even for two separate objects, providing a novel method of measurement 3D absolute shape without the requirements of high-quality phase, projector calibration, or spatial phase unwrapping.

### 4. Discussions

The proposed methods are advantageous over either single projector-camera based method, or the state-of-art active stereo based method. The major advantages of the proposed method are:
The proposed method combines merits of the random pattern based method with the phase-shifting-based method to achieve highest possible absolute 3D shape measurement speed by using the minimum number of phase-shifted fringe patterns (three), and to overcome the limitations of each individual method.
The proposed method completely eliminates the requirement of projector calibration, which is usually not easy and difficult to achieve high accuracy.
The present invention demonstrates that high-quality 3D shape measurement can be realized even with very poor quality phase data, alleviating the stringent requirements of the conventional high-quality 3D shape measurement.

In addition, it is to be understood that numerous options, variations, and alternatives may be implemented. For example, the phase-shifting patterns can be binarized with a dithering technique. The dithered binary patterns after passing through a low-pass filter will generate for good quality phase extraction by applying a phase-shifting algorithm; and the dithered patterns after passing through a high-pass filter will generate the statistical pattern for coarse stereo matching. Moreover, the dithered patterns can be defocused to generate modified sinusoidal patterns

Furthermore, different types of projectors may be used. For example, the projector may be regular video projector. Alternatively, the projector may be a slide projector. Where the projector is a slide projector, the phase-shifted patterns can be color coded onto the slide. Another option is that one single pattern can be printed on the slide, and phase shifts are generated by translating and/or rotating the physical slide. These printed patterns can be in grayscale or binarized. In the case of binarized patterns, the slide may even be panel with holes on the panel where the holes may represent 1s pixels and the rest represent 0s. Such an alternative may allow for mass production with an extremely low cost.

### 5. Applications

The proposed methods have numerous and significant applications for three dimensional sensing. These include incorporation of the necessary cameras and projectors into mobile devices such as phones and tablets, notebook computers, desktop computers, and/or accessories.

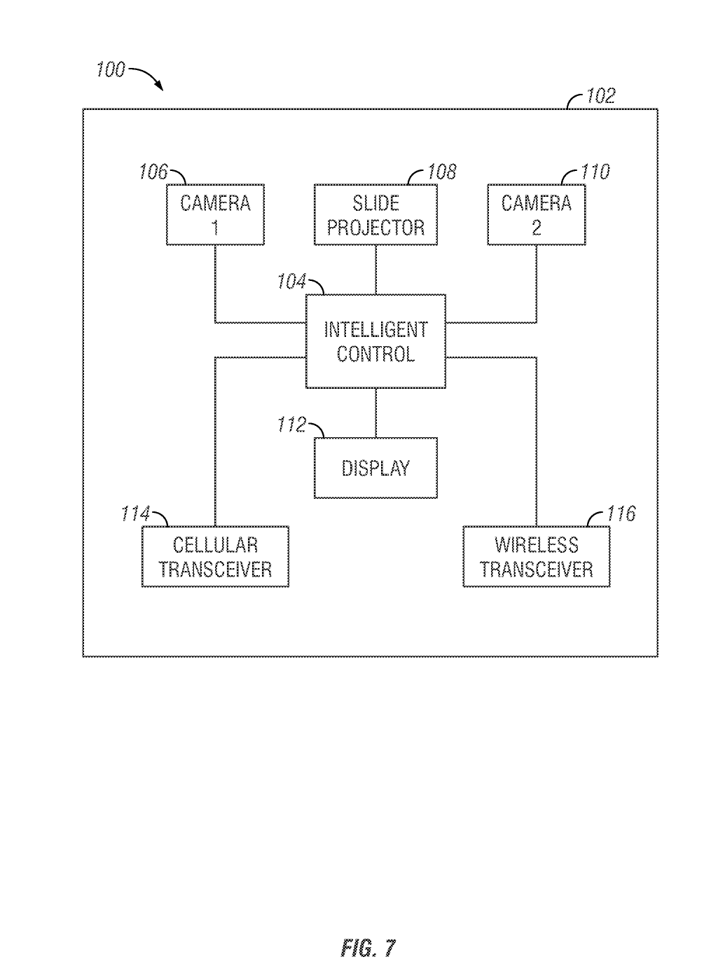

FIG. 7 is a block diagram of a mobile phone 100 with a mobile phone housing 102. The mobile phone 100 has an intelligent control 104 which may include a processor or microcontroller and associated hardware and circuitry. A first camera 106 and a second camera 110 are electrically connected to the intelligent control 104. A projector 108 is also electrically connected to the intelligent control 104. The projector 108 may be of any number of types of projectors. For example, the projector 108 may be a slide projector. Wherein the projector 108 is a slide projector, modified phase-shifting patterns may be printed on the slide of the projector 108. The modified phase-shifting patterns may be color coded on the slide, may be grayscale patterns, or may be binarized patterns. Where the patterns are binarized patterns, the slide may be a panel with holes to form the binarized patterns. It is also contemplated that the modified phase-shifting patterns may be generated by translating and/or rotating a slide containing one or more patterns in order to produce more patterns than are contained on the slide. The intelligent control 104 is programmed or otherwise configured to perform the methodology previously described. The mobile phone 100 may also include a cellular transceiver 114 and a wireless transceiver 116 electrically connected to the intelligent control 104. The cellular transceiver 114 may be used for cellular communications. The wireless transceiver 116 may be used for Wi-Fi communications. A display 112 is also electrically connected to the intelligent control 104.

Preferably the first camera 106 and the second camera 110 are separated from each other towards opposite sides of the housing 102 and preferably the projector 108 is generally centered between the first camera 106 and the second camera 110. The first camera 106, the second camera 110, and the projector 108 may be present on the same side of the mobile device as the display 112 or on a side of the mobile device different from the side at which the display 112 is provided, which may be an opposite side of the device.

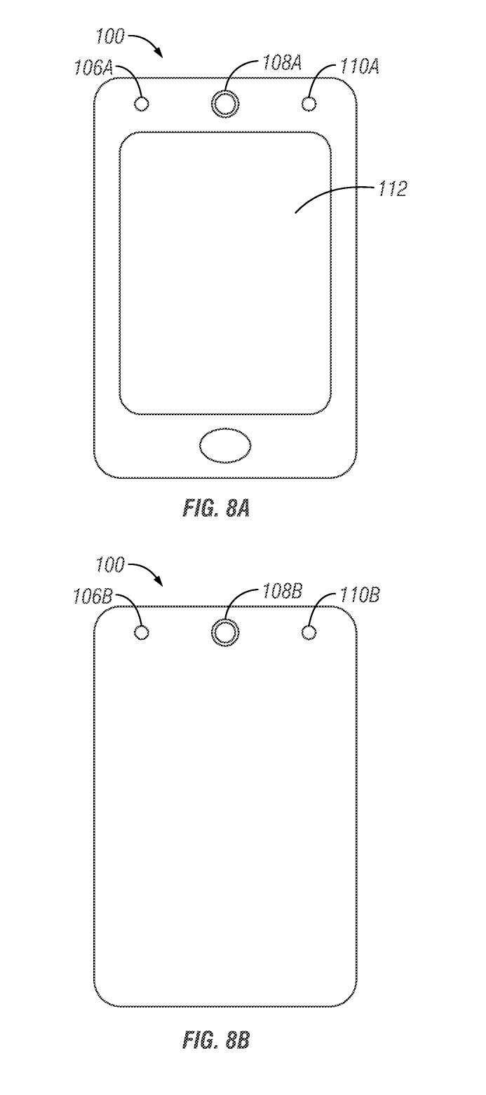

FIG. 8A illustrates one embodiment of the mobile device 100 with cameras 106A, 110A and a projector 108A positioned between the cameras 106A, 110A. Note that in the embodiment shown in FIG. 8A, the display 112 is on the same side as the cameras 106A, 110A, and the projector 108A. Thus, in this configuration, the cameras 106A, 110A and projector 108A face a user of the mobile device 100. This may be useful in various applications including three-dimensional calling. Thus, for example, the cameras 106A, 110A and the projector 108A may be used to provide three-dimensional shape measurement associated with a user and then this information may be communicated across a cellular communications channel or a wireless communication channel to another device similar to device 100 and displayed on the display of the other device. Similarly, three-dimensional shape measurement from the other device may be communicated to the device 100 and displayed on the display 112 so that two-way, three-dimensional video calling can be provided. FIG. 8B illustrates that the mobile device 100 may include cameras 106B, 110B, and projector 108B on the back of the device 100. This rear-facing configuration may be used to acquire three-dimensional images or video. It is contemplated that the cameras and projector may be present on both sides of the device 100 to allow for both forward-facing and rear-facing three-dimensional measurements to be acquired.

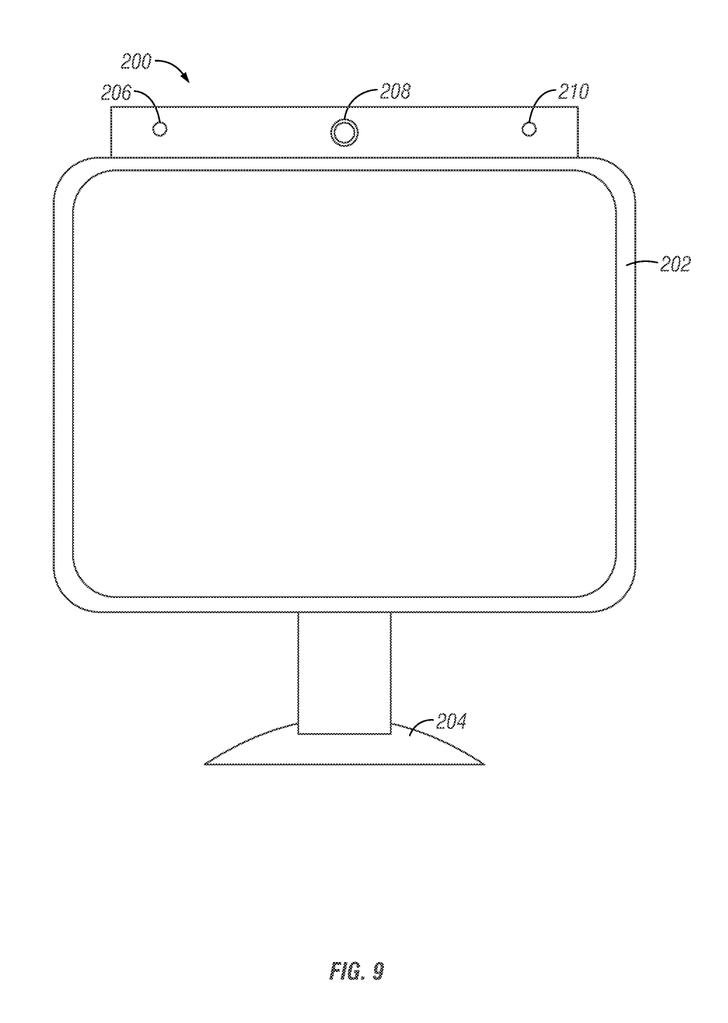

FIG. 9 illustrates another embodiment of a device 200 which may be placed on top of a monitor 202 resting on a monitor stand 204. The device 200 includes a first camera 206, a second camera 210 and a projector 208 positioned between the first camera 206 and the second camera 210. The device 200 may then be used to acquire three-dimensional images or video for various purposes including for video-conferencing, to detect user interactions such as user movement as a part of a user interface, or other purposes.

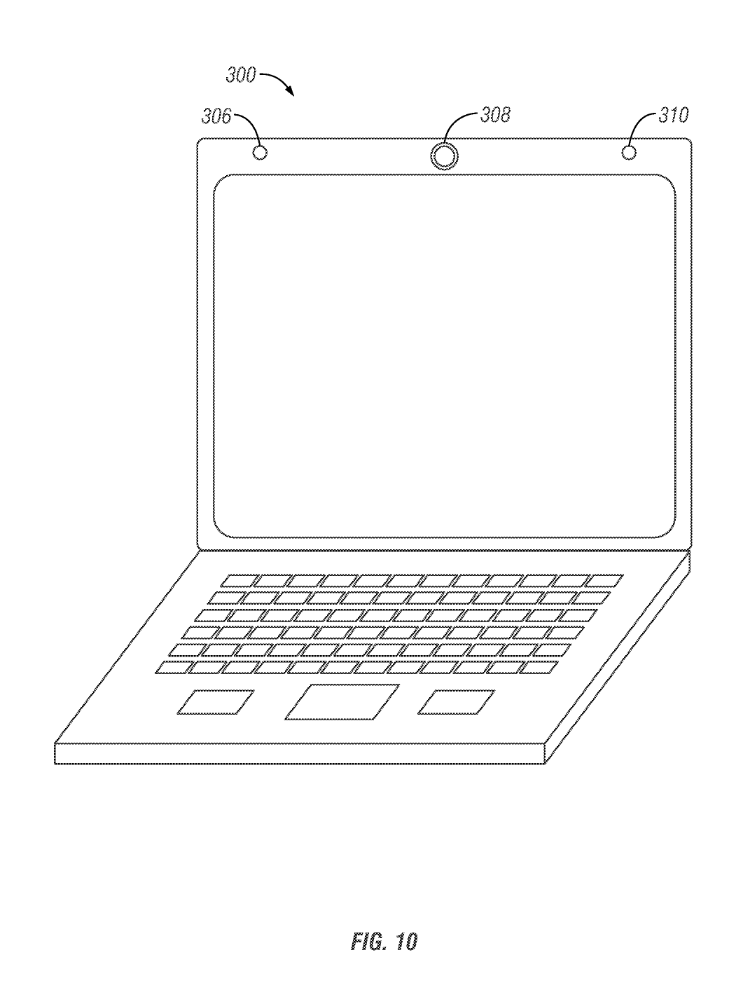

FIG. 10 illustrates another embodiment of a device 300 which may be a notebook computer with the cameras 306, 310 and projector 308 incorporated into the device 300 such as along a top edge of the device. The device 300 may be used to acquire three-dimensional images or video for various purposes including for video-conferencing, to detect user interactions such as user movement as a part of a user interface, or other purposes.

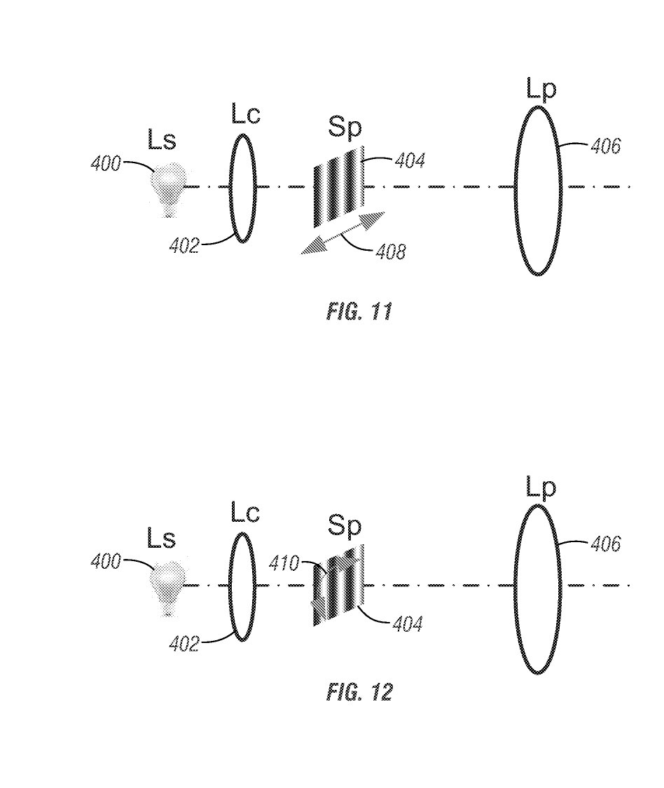

FIG. 11 illustrates one example of a configuration for a slide projector. As shown in FIG. 11, a light source 400 is shown. The light source may be an LED light source, lamp, or other light source used in projection. A lens for collimation 402 is aligned with the light source 400 and a slide 404. A lens for projection 406 is provided on the opposite side of the slide. As previously explained, the slide may have multiple fringe patterns on it, and the slide may be translated such as through side-to-side movement shown by arrow 408 in order to project different fringe patterns. This movement may be supplied in various way such as through manual movement by a user, use of an actuator such as a linear actuator, use of a motor and gearing, or otherwise.

FIG. 12 illustrates another example of a configuration for a slide projector. The example shown in FIG. 12 is similar to that shown in FIG. 11 except for instead of providing translation rotation is provided as shown by arrow 410. Slide movement may be initiated in various ways including manual movement or mechanized movement such as through use of a motor or actuator or otherwise.

Although various embodiments have been shown here, it is to be understood that these embodiments are merely representative and it is contemplated that numerous other types of devices may be configured to use the cameras and projector and methodology described herein. These include, without limitation, mobile phones, tablets, computers, notebook computers, gaming consoles, vehicles, machine vision systems, manufacturing vision systems, vision inspection systems, and numerous other types of applications.

Therefore methods and devices for three dimensional shape measurement have been shown and described. The present invention is not to be limited to the specific embodiments shown as the present invention contemplates numerous variations.

### References and Links

The following references are all incorporated by reference as if set forth herein.
1. D. Scharstein and R. Szeliski, “A taxonomy and evaluation of dense two-frame stereo correspondence algorithms,” Intl J. Comp. Vis. 47(1-3), 7-42 (2002).
2. U. R. Dhond and J. K. Aggarwal, “Structure from stereo-a review,” IEEE Trans.

Systems, Man. and Cybernetics 19(6), 1489-1510 (1989).
3. R. I. Hartley and A. Zisserman, Multiple View Geometry in Computer Vision

(Cambridge University Press, ISBN: 0521623049, 2000).
4. T. Kanade and M. Okutomi, “A stereo matching algorithm with an adaptive window: Theory and experiment,” IEEE Trans. Patt. Analy. and Mach. Intellig. 16(9), 920-932 (1994).
5. V. Kolmogorov and R. Zabih, “Multi-camera scene reconstruction via graph cuts,” in Euro Conf. Comp. Vis., pp. 82-96 (2002).
6. J. Kostková and R. Sára, “Stratified Dense Matching for Stereopsis in Complex Scenes.” in Proc. Brit. Mach. Vis. Conf., pp. 339-348 (2003).
7. H. Hirschmuller, “Stereo processing by semiglobal matching and mutual information,” IEEE Trans. Patt. Analysis Mach. Intellig. 30(2), 328-341 (2008).
8. F. Besse, C. Rother, A. W. Fitzgibbon, and J. Kautz, “PMBP: PatchMatch Belief Propagation for Correspondence Field Estimation,” Intl J. Comp. Vis. pp. 1-12 (2013).
9. A. Geiger, M. Roser, and R. Urtasun, “Efficient Large-Scale Stereo Matching,” 6492,25-38 (2011).
10. J. Salvi, S. Fernandez, T. Pribanic, and X. Llado, “A state of the art in structured light patterns for surface profilometry,” Patt. Recogn. 43(8), 2666-2680 (2010).
11. S. Zhang, “Recent progresses on real-time 3-D shape measurement using digital fringe projection techniques,” Opt. Laser Eng. 48(2), 149-158 (2010).
12. X. Chen, J. Xi, Y. Jin, and J. Sun, “Accurate calibration for a camera-projector measurement system based on structured light projection,” Opt. Laser Eng. 47(3), 310-319 (2009).
13. W. Janga, C. Jeb, Y. Seoa, and S. W. Leea, “Structured-light stereo: Comparative analysis and integration of structured-light and active stereo for measuring dynamic shape,” Opt. Laser Eng. 51(11), 12551264 (2013).
14. L. Zhang, B. Curless, and S. Seitz, “Spacetime Stereo: Shape Recovery for Dynamic Scenes,” in Proc. Comp. Vis. Patt. Recogn., pp. 367-374 (2003).
15. A. Wiegmann, H. Wagner, and R. Kowarschik, “Human face measurement by projecting bandlimited random patterns,” Opt. Express 14(17), 7692-7698 (2006).
16. X. Han and P. Huang, “Combined stereovision and phase shifting method: use of a visibility-modulated fringe pattern,” in SPIE Europe Optical Metrology, pp. 73,893H-73,893H (2009).
17. M. Schaffer, M. Groβe, B. Harendt, and R. Kowarschik, “Coherent two-beam interference fringe projection for highspeed three-dimensional shape measurements,” Appl. Opt. 52(11), 2306-2311 (2013).
18. K. Liu and Y. Wang, “Phase channel multiplexing pattern strategy for active stereo vision,” in Intl Conf. 3D Imaging (IC3D), pp. 1-8 (2012).
19. J. Salvi, J. Pages, and J. Batlle, “Pattern codification strategies in structured light systems,” Patt. Recogn. 37(4), 827-849 (2004).
20. P. Lutzke, M. Schaffer, P. Kühmstedt, R. Kowarschik, and G. Notni, “Experimental comparison of phase-shifting fringe projection and statistical pattern projection for active triangulation systems,” in SPIE Optical Metrology 2013, pp. 878,813-878,813 (2013).
21. C. Bräuer-Burchardt, M. Móller, C. Munkelt, M. Heinze, P. Kühmstedt, and G. Notni, “On the accuracy of point correspondence methods in three-dimensional measurement systems using fringe projection,” Opt. Eng. 52(6), 063,601-063,601 (2013).
22. Z. Li, K. Zhong, Y. Li, X. Zhou, and Y. Shi, “Multiview phase shifting: a full-resolution and high-speed 3D measurement framework for arbitrary shape dynamic objects,” Opt. Lett. 38(9), 1389-1391 (2013).
23. K. Zhong, Z. Li, Y. Shi, C. Wang, and Y. Lei, “Fast phase measurement profilometry for arbitrary shape objects without phase unwrapping,” Opt. Laser Eng. 51(11), 1213-1222 (2013).
24. C. Bräuer-Burchardt, P. Kühmstedt, and G. Notni, “Phase unwrapping using geometric constraints for high-speed fringe projection based 3D measurements,” in SPIE Optical Metrology 2013, pp. 878,906-878,906 (2013).
25. M. Maruyama and S. Abe, “Range sensing by projecting multiple slits with random cuts,” IEEE Trans. Patt. Analysis Mach. Intellig. 15(6), 647-651 (1993).
26. K. Konolige, “Projected texture stereo,” in IEEE Intl Conf. Rob. Auto., pp. 148-155 (2010).
27. Y. Wang and S. Zhang, “Superfast multifrequency phase-shifting technique with optimal pulse width modulation,” Opt. Express 19(6), 5143-5148 (2011).

What is claimed is:

1. A method for three-dimensional (3D) shape measurement, comprising:
providing a system comprising a first camera, a second camera, and a projector;
combining phase-shifting fringe patterns with statistically random patterns to produce modified phase-shifting fringe patterns;
projecting the modified phase-shifting patterns with the projector onto a surface;
acquiring imagery of the surface using the first camera and the second camera;
applying a stereo matching algorithm to the imagery to obtain a coarse disparity map;
using local phase information to further refine the coarse disparity map to thereby provide the 3D shape measurement.

2. The method of claim 1 wherein the phase-shifting fringe patterns are binarized with a dithering technique to produce dithered binary patterns.

3. The method of claim 2 further comprising passing the dithered binary patterns through a low-pass filter.

4. The method of claim 2 further comprising passing the dithered binary patterns through a high pass filter to generate the statistically random patterns.

5. The method of claim 1 wherein the projector is a video projector.

6. The method of claim 1 wherein the projector is a slide projector.

7. The method of claim 6 wherein the modified phase-shifting patterns are printed on a slide.

8. The method of claim 7 wherein the modified phase-shifting patterns are color coded on the slide.

9. The method of claim 7 wherein the modified phase-shifting patterns are binarized patterns.

10. The method of claim 9 wherein the slide is a panel with holes to form the binarized patterns.

11. The method of claim 6 wherein the modified phase-shifting patterns are generated from translating and/or rotating a slide containing one or more patterns.

12. The method of claim 1 wherein the projector is a video projector.

13. The method of claim 1 further comprising constructing an image based on the 3D shape measurement.

14. The method of claim 13 further comprising displaying the image based on the 3D shape measurement.

15. The method of claim 1 wherein the system is a mobile device.

16. The method of claim 15 wherein the mobile device comprises a phone.

17. The method of claim 16 wherein the first camera and the second camera are mounted on a front of the mobile device, a display also on the front of the mobile device and the first camera, the second camera, and the display face a user.

18. The method of claim 17 wherein the mobile device is further configured for video calls.

19. The method of claim 1 wherein the first camera, the second camera, and the projector are positioned adjacent to a display of the system.

20. The method of claim 1 wherein the phase-shifting patterns comprise at least three phase-shifting patterns.

21. An apparatus for 3-D shape measurement, the apparatus comprising:
a first camera;
a second camera;
a projector;
a computing device operatively connected to the first camera, the second camera, and the projector;
wherein the computing device is configured to perform steps of combining phase-shifting fringe patterns with statistically random patterns to produce modified phase-shifting fringe patterns, projecting the modified phase-shifting patterns with the projector onto a surface, acquiring imagery of the surface using the first camera and the second camera, applying a stereo matching algorithm to the imagery to obtain a coarse disparity map, and using local phase information to further refine the coarse disparity map to thereby provide the 3D shape measurement.

22. The apparatus of claim 21 wherein the apparatus further comprises a display and wherein the computing device is configured to construct imagery based on the 3D shape measurement and display the image on the display.

23. The apparatus of claim 21 wherein the apparatus further comprises a wireless transceiver and wherein the computer device is configured to communicate the 3D shape measurement across a communications channel using the wireless transceiver.

24. The apparatus of claim 23 wherein the apparatus is further configured to receive 3D shape measurements from across the communications channel and display imagery based on the 3D shape measurements from across the communications channel on the display.

25. The apparatus of claim 21 wherein the projector is a slide projector.

26. The apparatus of claim 21 wherein the apparatus is a mobile device.

27. The apparatus of claim 26 wherein the mobile device comprises a phone.

28. The apparatus of claim 27 wherein the first camera, the second camera, and the projector are mounted on a front side of the phone to face a user of the phone.

29. The apparatus of claim 27 wherein the first camera, the second camera, and the projector are mounted on a back side of the phone to face away from a user of the phone.
